(19) United States
(12) Patent Application Publication
(10) Pub. No.: US 2026/0285409 A1
(43) Pub. Date: Sep. 24, 2026

(54) REAR BUMPER ASSEMBLY FOR A VEHICLE

(71) Applicant: NISSAN NORTH AMERICA, INC., Franklin, TN (US)

(72) Inventors: Takuji KUGAYA, Commerce TWP, MI (US); Goutham YARLAGADDA, Novi, MI (US)

(21) Appl. No.: 19/086,037

(22) Filed: Mar. 20, 2025

(51) Int. Cl. B62D 25/08; B62D 21/15

(52) U.S. Cl. CPC B62D 25/08; B62D 21/155

(57) ABSTRACT

A rear bumper assembly for a vehicle includes a rear fascia and a water prevention element. The rear fascia is configured to be connected to a vehicle body structure. The rear fascia has an inner surface and an outer surface. The water prevention element is provided to the rear fascia and is configured to prevent water from passing a seal member connected to the rear panel.

### BACKGROUND

### Technical Field

The present disclosure generally relates to a rear bumper assembly for a vehicle. More specifically, the present disclosure relates to a water prevention element provided to a rear fascia configured to substantially prevent water from passing a seal member of the rear bumper assembly of a vehicle.

### Background Information

Water, particularly water at a high pressure, can enter a gap between a closed rear door and a rear fascia of a rear bumper assembly. The water passing through the gap between the rear door and the rear fascia can strike a seal of a vehicle body structure. The water striking the seal can result in water leaking through the seal and puddling inside a vehicle cabin.

### SUMMARY

A need exists for an improved rear bumper assembly that substantially prevents water entering a gap between a rear door and a rear fascia of a rear bumper assembly from entering an interior of a vehicle.

In view of the state of the known technology, one aspect of the present disclosure is to provide a rear bumper assembly for a vehicle. The rear bumper assembly includes a rear fascia and a water prevention element. The rear fascia is configured to be connected to a vehicle body structure. The rear fascia has an inner surface and an outer surface. The water prevention element is provided to the rear fascia and is configured to prevent water from passing a seal member connected to the rear panel.

Another aspect of the present disclosure is to provide a vehicle including a vehicle body structure, a rear door, a seal member, and a fascia assembly. The rear door is pivotally connected to the vehicle body structure. The seal member is connected to the vehicle body structure. The rear door is configured to overlie the seal member when the rear door is in a closed position. The rear bumper assembly is connected to the vehicle body structure. The rear bumper assembly includes a rear fascia and a water prevention element. The rear fascia is connected to the vehicle body structure. The rear fascia has an inner surface and an outer surface. The water prevention element is provided to the rear fascia and is configured to prevent water from passing the seal member.

Also other objects, features, aspects and advantages of the disclosed rear bumper assembly for a vehicle will become apparent to those skilled in the art from the following detailed description, which, taken in conjunction with the annexed drawings, discloses exemplary embodiments of the rear bumper assembly for a vehicle.

### BRIEF DESCRIPTION OF THE DRAWINGS

Referring now to the attached drawings which form a part of this original disclosure:

FIG. 1 is a perspective view of a vehicle equipped with a rear fascia assembly in accordance with an exemplary embodiment;

FIG. 2 is a front elevational view of the vehicle body structure and the rear bumper assembly of FIG. 1 in which a water prevention element is a rib extending outwardly from a rear fascia;

FIG. 3 is an exploded perspective view of the rib extending outwardly from an outer surface of the rear fascia of the rear bumper assembly of FIG. 2;

FIG. 4 is a side elevational view in cross section of the vehicle body structure and the rear bumper assembly of FIG. 2;

FIG. 5 is the side elevational view in cross section of the vehicle body structure and the rear bumper assembly of FIG. 4 in which the rib deflects a water path of water passing through a gap between a rear door and the rear fascia;

FIG. 6 is a perspective view of a vehicle body structure and a rear bumper assembly in accordance with another exemplary embodiment in which a water prevention element is an opening disposed in the rear fascia;

FIG. 7 is a front elevational view of a rear fascia of the rear bumper assembly of FIG. 7 illustrating the opening in the rear fascia;

FIG. 8 is a side elevational view in cross section of the vehicle body structure and the rear bumper assembly of FIG. 6 illustrating the opening in the rear fascia;

FIG. 9 is a perspective view of the vehicle body structure and the rear fascia assembly of FIG. 8 illustrating the opening in the rear fascia; and

FIG. 10 is a side elevational view in cross section of the vehicle body structure and the rear fascia assembly of FIG. 8 in which a water path of water passing through a gap between a rear door and the rear fascia is deflected by the opening in the rear fascia.

### DETAILED DESCRIPTION OF EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

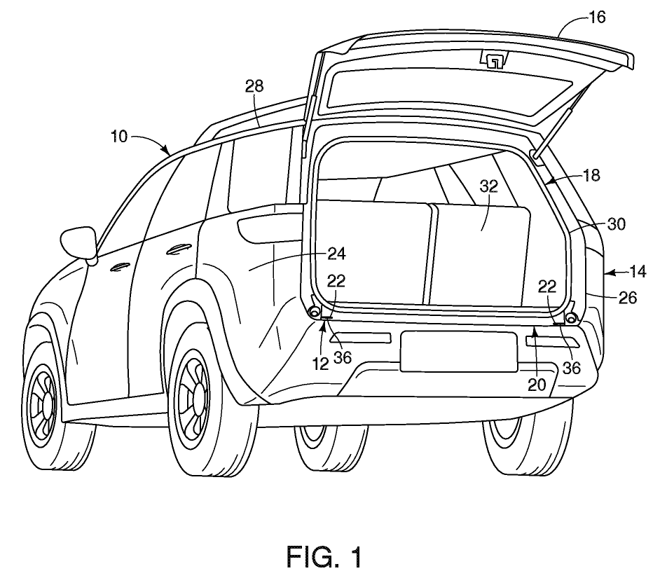

Referring initially to FIGS. 1 – 5, a vehicle 10 including a rear bumper assembly 12 is illustrated in accordance with an exemplary embodiment. The vehicle 10 includes a vehicle body structure 14, a rear door 16, a seal member 18, and the rear bumper assembly 12. The rear door 16 is pivotally connected to the vehicle body structure 14. The seal member 18 is connected to the vehicle body structure 14. The rear bumper assembly 12 includes a rear fascia 20 and a water prevention element 22.

The vehicle body structure 14 includes many conventional structural and support elements. The vehicle body structure 14 includes, among other features, side structures 24, a rear structure 26 and a roof structure 28 that are rigidly connected to one another by, for example, various welding techniques. The vehicle body structure 14 and support elements thereof are well known, such that further description thereof is omitted for the sake of brevity.

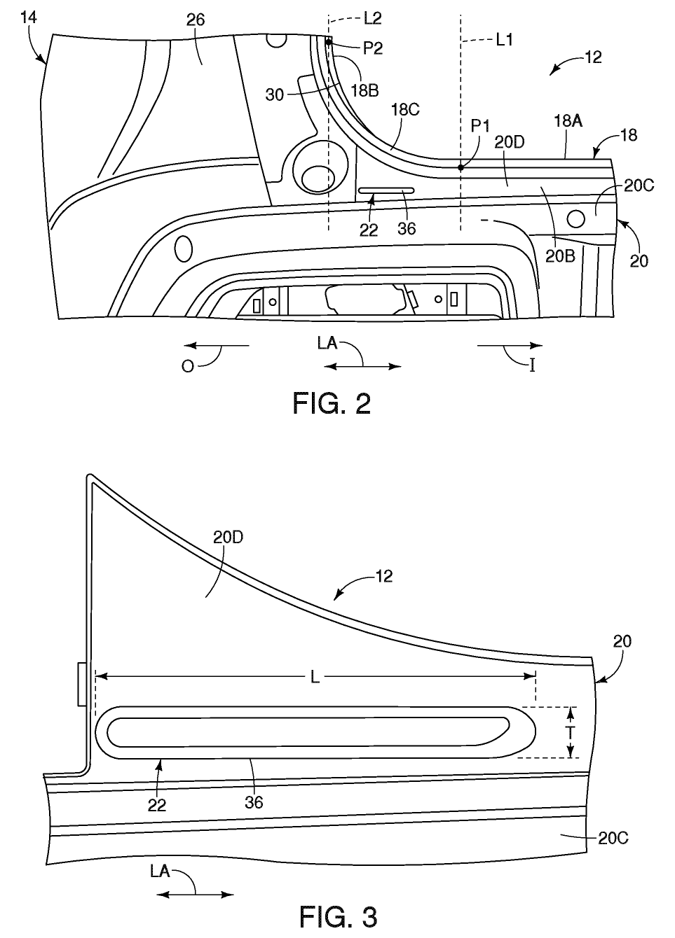

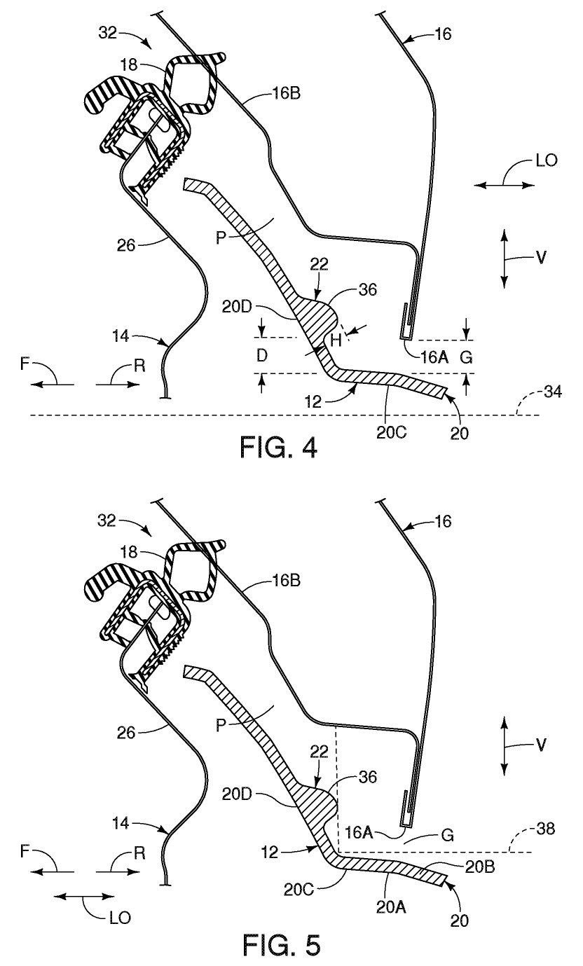

An opening 30 is disposed in the vehicle body structure 14, as shown in FIGS. 1 and 2. The rear structure 26 of the vehicle body structure 14 defines the rear door opening 30. The rear door 16 is pivotally connected to the vehicle body structure 14, as shown in FIG. 1, in any suitable manner. The rear door 16 is configured to overlay the opening 30 when the rear door 16 is in a closed position, as shown in FIG. 4. The rear door 16 is configured to provide access through the opening 26 to an interior 32 of the vehicle 10 when the rear door 16 is in the open position, as shown in FIG. 1.

The vehicle body structure 14 supports the rear bumper assembly 12, as shown in FIGS. 1 and 2. The rear bumper assembly 12 is connected to the rear structure 26 of the vehicle body structure 14 in any suitable manner. The rear bumper assembly 12 includes the rear fascia 20. The rear fascia 20 of the rear bumper assembly 12 is connected to the rear structure 26 of the vehicle body structure 14. The rear fascia 20 has an inner surface 20A and an outer surface 20B. The inner surface 20A of the rear fascia faces the rear structure 26 of the vehicle body structure 14. The outer surface 20B of the rear fascia 20 faces the rear door 16 when the rear door 16 is in the closed position, as shown in FIGS. 4 and 5.

The rear fascia 20 has a first portion 20C and a second portion 20D, as shown in FIGS. 2 – 5. The first portion 20C of the rear fascia 20 is disposed beneath the lower end 16A of the rear door 16. The second portion 20D of the rear fascia 20 extends outwardly from the first portion 20C in a forward direction F of the vehicle 10. As shown in FIGS. 4 and 5, the second portion 20D of the rear fascia 20 is angularly disposed relative to the first portion 20C.

A gap G is defined between a lower end 16A of the rear door 16 and the outer surface 20B of the rear fascia 20 when the rear door 16 is in the closed position, as shown in FIGS. 4 and 5. The gap G is defined between the lower end 16A of the rear door 16 and the outer surface 20B of the rear fascia 20 disposed below the lower end 16A of the rear door 16 in a vertical direction V. In other words, the gap G is defined between the first portion 20C of the rear fascia 20 and the lower end 16A of the rear door 16. The vertical direction V is substantially perpendicular to a ground surface 34.

The seal member 18 is connected to the vehicle body structure 14, as shown in FIGS. 4 and 5. The seal member 18 is connected to the rear structure 26 of the vehicle body structure 14. The seal member 18 is preferably disposed about an entirety of the rear structure 26 defining the opening 30, as shown in FIGS. 1 and 2. Preferably, the seal member 18 is integrally formed as a one-piece member. The seal member 18 provides a seal with the rear door 16 in the closed position, as shown in FIG. 4, to substantially prevent water from entering the interior 32 of the vehicle 10. In other words, the rear door 16 is configured to overlie the seal member 18 when the rear door 16 is in the closed position when viewed in a longitudinal direction LO of the vehicle 10.

The seal member 18 has a first substantially linear portion 18A and a second substantially linear portion 18B, as shown in FIG. 2. The first substantially linear portion 18A extends substantially horizontally. The second substantially linear portion 18B extends substantially vertically. The second substantially linear portion 18B is substantially perpendicular to the first substantially linear portion 18A. A curved portion 18C of the seal member 18 connects the first and second substantially linear portions 18A and 18B. The curved portion 18C has a first end P1 and a second end P2 and extends therebetween.

A passage P is defined between the outer surface 20B of the rear fascia 20 and an inner panel 16B of the rear door 16. The passage P extends along an outer surface 20B of the first portion 20C and the second portion 20D of the rear fascia 20. The passage P extends from the gap G to the seal member 18. The seal member 18 is configured to substantially prevent water entering the passage P through the gap G from entering the interior 32, such as the vehicle cabin, of the vehicle 10.

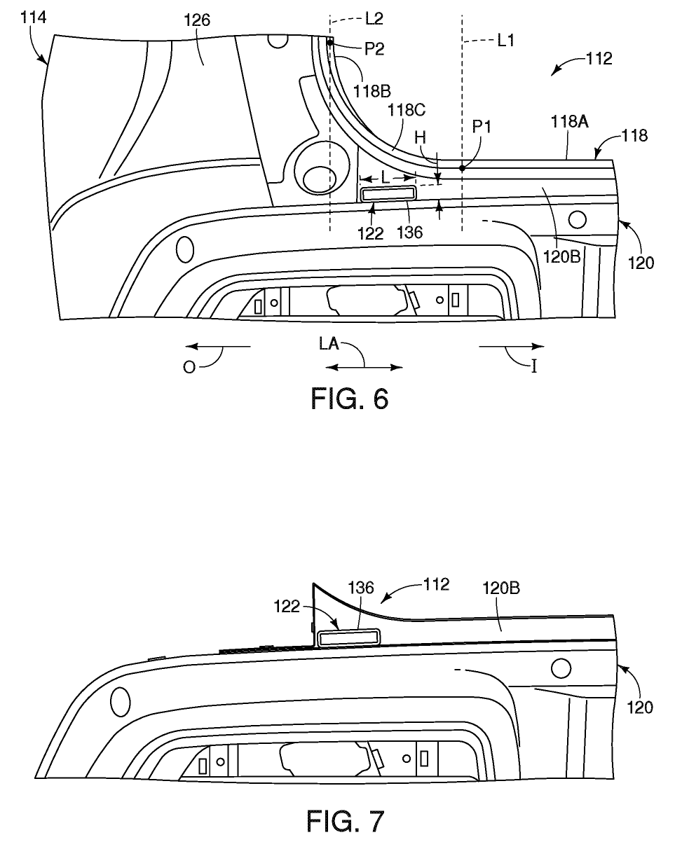

To further facilitate the seal member 18 substantially preventing water from entering the vehicle interior 32, a water prevention element 22, such as a rib 36 (FIGS. 1 – 5) or an opening 136 (FIGS. 6 – 10) is provided to the rear fascia 20. The water prevention element 22 is configured to substantially prevent water from passing, or leaking through, the seal member 18. As shown in FIG. 1, a water prevention element 22 is disposed on the driver and passenger sides of the vehicle 10. The water prevention element 22 on the passenger side is substantially identically formed as the water prevention element on the driver side of the vehicle 10, such that only the water prevention element 22 on the driver side is discussed below.

As shown in FIGS. 2 – 5, the rib 36 extends outwardly from the outer surface 20B of the rear fascia 20. The rib 36 can be made of any suitable material, such as plastic. Preferably, the rib 36 is made of the same plastic material as the rear fascia 20, such as polypropylene. The rib 36 is disposed on the second portion 20D of the rear fascia 20. The rib 36 is disposed in the forward direction F of the vehicle 10 with respect to the gap G. The rib 36 is preferably integrally formed with the rear fascia 20, such as by injection molding.

The rib 36 is disposed proximate to the curved portion 18C of the seal member 18, as shown in FIG. 2. The rib 36 preferably does not extend beyond the curved portion 18C of the seal member 18 in a lateral direction of the vehicle 10. In other words, the rib 36 is entirely disposed within virtual lines L1 and L2 passing through the end points P1 and P2 of the curved portion 18C. The virtual lines L1 and L2 are parallel to one another and are perpendicular to the lateral direction LA of the vehicle 10. In other words, the rib 36 preferably does not extend laterally in an inboard direction I of the vehicle 10 beyond the virtual line L1, and the rib 36 does not extend laterally in an outboard direction O of the vehicle 10 beyond the virtual line L2.

The rib 36 extends in a lateral direction LA of the vehicle 10, as shown in FIGS. 2 – 5. The rib 36 has a length L, a thickness T and a height H. The length L of the rib 36 extends in the lateral direction LA of the vehicle 10. The rib 36 can have any suitable length, such as approximately 100mm. The thickness T of the rib 36 is in a direction perpendicular to the lateral direction LA of the vehicle along the outer surface 20B of the rear fascia 20. The rib 36 can have any suitable thickness T, such as approximately 2.5mm. The height H of the rib 36 is in a direction perpendicular to the outer surface 20B of the rear fascia 20. The rib 36 can have any suitable height, such as approximately 5mm. The thickness T of the rib 36 is less than a height H of the rib 36. A length L of the rib 36 is larger than a thickness T of the rib 36 and larger than a height H of the rib 36.

The rib 36 is disposed at a distance D from the outer surface 20B of the first portion 20C of the rear fascia 20, as shown in FIG. 4. The distance D is measured in a direction substantially perpendicular to the outer surface 20B of the rear fascia 20 from a portion of the outer surface 20B disposed beneath the lower end 16A of the rear door 16. The distance D is any suitable distance that prevents the rib 36 from being visible when the rear door 16 is in the closed position. The distance D is preferably at least the distance of the gap G. The distance D is preferably approximately 6.0mm.

The rib 36 is configured to substantially prevent water, such as high-pressure water, from passing, or leaking through, the seal member 18, as shown in FIG. 5. Water 38, such as high-pressure water when washing the vehicle 10, can enter the gap G between the rear door 16 and the rear fascia 20. The flow of the water 38 entering the gap G is deflected by the rib 36. The rib 36 prevents the water 38 entering the gap G from flowing through the passage P and directly striking the seal member 18. As shown in FIG. 5, the rib 36 deflects the flow of the water 38 through the gap G toward the inner panel 16B of the rear door 16. The rib 36 prevents the water 38 from directly striking the seal member 18, such that water leaking through the seal member 18 into the vehicle interior 32 is substantially prevented.

As shown in FIGS. 12 – 16, a rear door assembly 112 in accordance with another illustrated exemplary embodiment is substantially similar to the rear door assembly 12 of the exemplary embodiment illustrated in FIGS. 1 – 11 except for the differences described below. Similar parts are identified with similar reference numerals, except increased by 100 (i.e., 1xx, accordingly).

The rear door assembly 112 of FIGS. 6 – 10 is substantially similar to the rear door assembly 12 of FIGS. 1 - 5 except that, in lieu of the rib 36, the water prevention element 122 of the rear door assembly 112 is an opening 136 disposed in the rear fascia 120.

As shown in FIGS. 6 – 10, the opening 136 extends from the outer surface 120B to the inner surface 120A of the rear fascia 120. The opening 136 preferably has a substantially oval-shape, although the opening 136 can have any suitable shape.

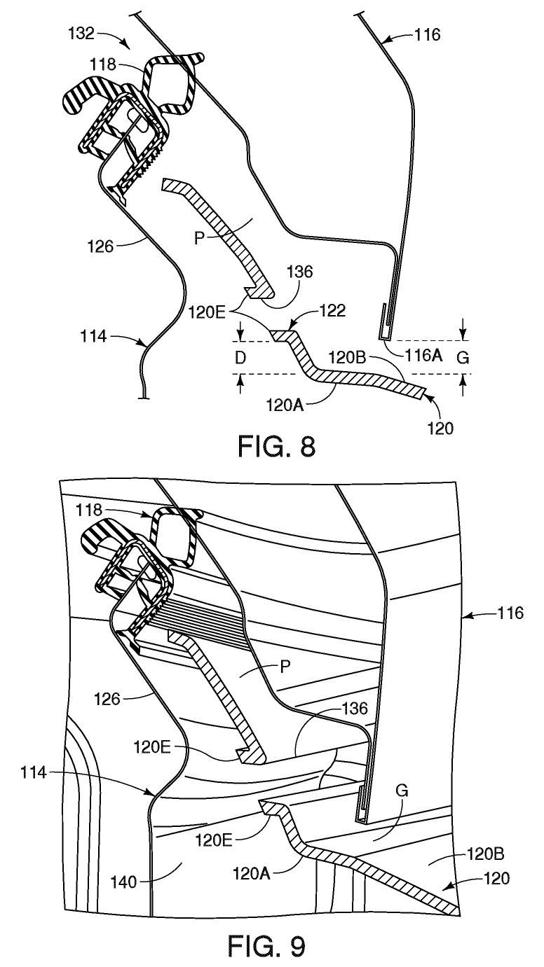

A lip 120E extends inwardly from the opening 136, as shown in FIGS. 8 – 10. The lip 120E extends inwardly from the inner surface 120A of the rear fascia 120. The lip 120E preferably surrounds an entirety of the opening 136 on the inner surface 120A of the rear fascia 120. In other words, the lip 120E extends inwardly from the inner surface 120A of the rear fascia 120 along a circumference of the opening 136. The lip 120E is preferably integrally formed with the rear fascia 120, such as by injection molding.

The seal member 118 is connected to the rear structure 126 of the vehicle body structure 114, as shown in FIGS. 6 and 8 – 10. The seal member 118 has a first substantially linear portion 118A and a second substantially linear portion 118B, as shown in FIG. 6. The first substantially linear portion 118A extends substantially horizontally. The second substantially linear portion 118B extends substantially vertically. The second substantially linear portion 118B is substantially perpendicular to the first substantially linear portion 118A. A curved portion 118C of the seal member 118 connects the first and second substantially linear portions 118A and 118B. The curved portion 18C has a first end P1 and a second end P2 and extends therebetween.

The opening 136 is disposed proximate to the curved portion 118C of the seal member 118, as shown in FIG. 6. The opening 136 preferably does not extend beyond the curved portion 118C of the seal member 118 in the lateral direction LA of the vehicle. The curved portion 118C has a first end P1 and a second end P2. In other words, the opening 136 is entirely disposed within virtual lines L1 and L2 passing through the end points P1 and P2 of the curved portion 118C. The virtual lines L1 and L2 are parallel to one another and are perpendicular to the lateral direction LA of the vehicle. In other words, the opening 136 preferably does not extend laterally in an inboard direction I of the vehicle beyond the virtual line L1, and the opening 136 does not extend laterally in an outboard direction O of the vehicle beyond the virtual line L2.

The opening 136 is disposed in a location substantially identical to the location of the rib 36. The opening 136 extends in a lateral direction LA of the vehicle 10, as shown in FIGS. 6 and 7. The opening 136 has a length L and a height H. The length L of the opening 136 extends in the lateral direction LA of the vehicle. The opening 136 can have any suitable length, such as approximately 100mm. The height H of the opening 136 is in a direction perpendicular to the lateral direction LA of the vehicle. The opening 136 can have any suitable height H, such as approximately 2.5mm. The length L of the opening 136 is larger than the height H of the opening 136.

The opening 136 is disposed at a distance D from the outer surface 120B of the rear fascia 120, as shown in FIG. 8. The distance D is measured in a direction substantially perpendicular to the outer surface 120B of the rear fascia 120 from a portion of the outer surface 120B disposed beneath the lower end 116A of the rear door 116. The distance D is any suitable distance that prevents the opening 136 from being visible when the rear door 116 is in the closed position. The distance D is preferably approximately 6.0mm.

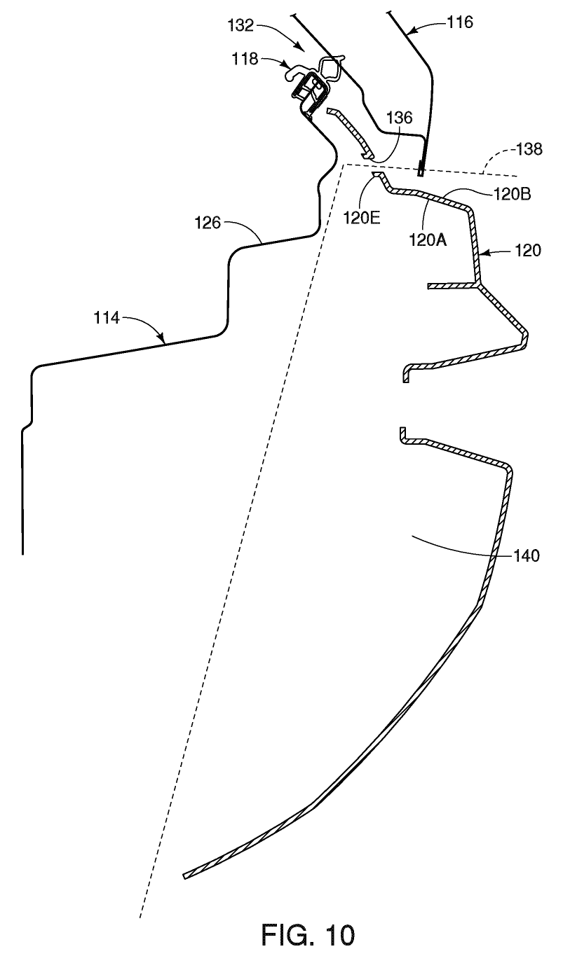

The opening 136 is configured to substantially prevent water, such as high-pressure water, from passing, or leaking through, the seal member 118, as shown in FIG. 10. Water 138, such as high-pressure water when washing the vehicle, can enter the gap G between the rear door 116 and the rear fascia 120. The flow of the water 138 entering the gap G passes through the opening 136 in the rear fascia 120. The opening 136 prevents the water 138 entering the gap G from flowing through the passage P and directly striking the seal member 118. As shown in FIG. 10, the flow of the water 138 through the gap G enters the opening 136 and drains to the ground. The water 138 passing through the opening 136 drains to the ground through a cavity 140 defined between the rear fascia 120 and the rear structure 126 of the vehicle body structure 114. The opening 136 prevents the water 138 from directly striking the seal member 118, such that water leaking through the seal member 118 into the vehicle interior 132 is substantially prevented.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the rear bumper assembly. Accordingly, these terms, as utilized to describe the present invention should be interpreted relative to a vehicle equipped with the rear bumper assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A rear bumper assembly for a vehicle, the rear bumper assembly comprising:
a rear fascia configured to be connected to a vehicle body structure, the rear fascia having an inner surface and an outer surface; and
a water prevention member provided to the rear fascia and configured to prevent water from passing a seal member connected to the rear panel.

2. The rear bumper assembly according to claim 1, wherein
the water prevention member is a rib extending outwardly from the outer surface of the rear fascia.

3. The rear bumper assembly according to claim 2, wherein
the rib extends in a lateral direction of the vehicle.

4. The rear bumper assembly according to claim 3, wherein
a thickness of the rib is less than a height of the rib.

5. The rear bumper assembly according to claim 3, wherein
a length of the rib is larger than a thickness of the rib and larger than a height of the rib.

6. The rear bumper assembly according to claim 2, wherein
the rib is integrally formed with the rear fascia.

7. The rear bumper assembly according to claim 2, wherein
the rib is made of plastic.

8. The rear bumper assembly according to claim 1, wherein
the water prevention member is an opening extending from the outer surface to the inner surface of the rear fascia.

9. The rear bumper assembly according to claim 8, wherein
the opening is substantially oval-shaped.

10. The rear bumper assembly according to claim 9, wherein
a length of the opening is larger than a height of the opening.

11. The rear bumper assembly according to claim 8, wherein
a lip extends inwardly from the inner surface of the fascia along a circumference of the opening.

12. A vehicle comprising:
a vehicle body structure;
a rear door pivotally connected to the vehicle body structure;
a seal member connected to the vehicle body structure; the rear door being configured to overlie the seal member when the rear door is in a closed position; and
a rear bumper assembly connected to the vehicle body structure, the rear bumper assembly including
a rear fascia connected to the vehicle body structure, the rear fascia having an inner surface and an outer surface; and
a water prevention member provided to the rear fascia and configured to prevent water from passing the seal member.

13. The rear bumper assembly according to claim 12, wherein
the seal member has a first substantially linear portion, a second substantially linear portion, and a curved portion connecting the first and second substantially linear portions,
the water prevention member being disposed proximate to the curved portion.

14. The rear bumper assembly according to claim 13, wherein
the water prevention member does not extend beyond the curved portion of the seal member in a lateral direction of the vehicle.

15. The rear bumper assembly according to claim 13, wherein
the water prevention member is a rib extending outwardly from the outer surface of the rear fascia.

16. The rear bumper assembly according to claim 15, wherein
the rib extends in a lateral direction of the vehicle.

17. The rear bumper assembly according to claim 16, wherein
a length of the rib is larger than a thickness of the rib and larger than a height of the rib.

18. The rear bumper assembly according to claim 13, wherein
the water prevention member is an opening extending from the outer surface to the inner surface of the rear fascia.

19. The rear bumper assembly according to claim 18, wherein
the opening is substantially oval-shaped.

20. The rear bumper assembly according to claim 18, wherein
a lip extends inwardly from the inner surface of the fascia along a circumference of the opening.
